(19) United States
(12) Patent Application Publication
(10) Pub. No.: US 2012/0231127 A1
(43) Pub. Date: Sep. 13, 2012

(54) FOAMING BEVERAGES CONTAINING LIPIDS

(76) Inventors: Steven FINLEY, Wayne, NJ (US); Rustam H. Sethna, Clinton, NJ (US); Daniel A. Morgan, Westfield, NJ (US)

(21) Appl. No.: 13/045,714

(22) Filed: Mar. 11, 2011

(51) Int. Cl. A23L 2/54; B65B 31/02; A23P 1/16; A23L 2/38

(52) U.S. Cl. 426/116; 426/474; 426/404; 426/569

(57) ABSTRACT

A method for making a foaming beverage includes providing a beverage having at least one lipid-based ingredient therein and mixing nitrous oxide with said beverage. A beverage having a foam composition includes a liquid having at least one lipid-based ingredient therein and nitrous oxide mixed into the liquid. The nitrous oxide may be in gas phase.

### BACKGROUND

The present embodiments relate to modifying the appearance and mouth feel of beverages to have for example a foaming consistency.

It is known that mixing heavy cream with nitrous oxide (N₂O) gas under pressure forms small bubbles within the mixture. Under pressure, the gas/cream mixture remains stable and nitrous oxide gas provides protection against spoilage due to microorganism activity. Accordingly, cream stored with nitrous oxide has a longer shelf life than cream stored alone. When the cream/nitrous oxide mixture is dispensed from a pressurized container, the pressure of the mixture is reduced substantially and accordingly fine bubbles in the mixture expand. The gas is very soluble in fatty compounds, such as cream. In aerosol whipped products, it is dissolved in the cream under pressure. When released, the pressure is reduced and the dissolved nitrous oxide gas expands, creating foam. Such expansion provides for an increased volume of the mixture up to as much as four times the original volume. The preservation effect works with a full range of lipids or fat-based dairy products. The nitrous oxide also displaces oxygen in the product thereby further protecting the product and any lipids or oil therein from becoming rancid.

Carbonation is not necessarily desirable for beverages or drinks containing dairy products, for example ready-to-drink coffee beverages or some fruit/dairy beverage mixtures, yogurt based beverages or dairy beverages such as chocolate-flavored dairy drinks.

### DETAILED DESCRIPTION OF THE EMBODIMENT

The present embodiments provide a method to improve the appearance and mouth feel of non-carbonated beverages which contain fats and/or oils in such compositions. The beverage may be a fruit or vegetable juice of any flavour or combination of fruit and vegetable juices. The beverage can also be a syrup. In the beverages, a thick, foamy, creamy head may be obtained.

The present embodiments call for preparation of the beverage by having nitrous oxide mixed with a particular liquid or beverage. An amount of nitrous oxide to be mixed with the beverage is determined by the ratio of lipid-based ingredients in the beverage, for example, a ratio of dairy to the water-based components. Further, the quantity of nitrous oxide to be mixed into the beverage is determined by the desired effect, specifically, the desired increase in volume and consistency of the head or foam to be produced in the beverage.

The quantity of nitrous oxide that can be mixed into the beverage is a function of the temperature and the pressure of the beverage to be mixed. Generally, increasing the pressure of the mixture with the nitrous oxide or increasing the pressure of the beverage as the nitrous oxide is being added to it permits the beverage to contain an increased amount of nitrous oxide gas. The addition of the nitrous oxide gas to the beverage is itself sufficient to also increase the pressure of the mixture to thereby permit an increase in the amount of nitrous oxide that can be contained in the beverage. The pressure range for mixing the nitrous oxide into the beverage may be from to 1 to 10 barg (14.5 to 145 psig) by way of example only. When the temperature of the mixture or beverage is decreased, the beverage or mixture's capacity to contain nitrous oxide is increased as well. The temperature range for which the nitrous oxide is to be mixed with the beverage may be from 0° to 10° C. (32° to 50° F.) by way of example only.

The amount of nitrous oxide added to the lipid-containing beverage will solubilise with the lipid-containing portion of the beverage and the water in the beverage. However, it is that portion of the nitrous oxide gas dissolved in the lipid portion of the beverage that produces the foamy, creamy effect. The nitrous oxide is dissolved and comes out of solution as a gas to create a foam for the beverage. This enhances the appearance and the mouth feel of non-carbonated beverages that contain a significant amount of lipid-based ingredients, such as for example dairy based beverages.

### EXAMPLE 1

In a first representative embodiment, nitrous oxide gas is mixed with a beverage containing lipids using known equipment, such as that equipment used in the soft drink industry for carbonation. The water and lipid components of the beverage may be de-aerated to displace dissolved oxygen in the beverage, i.e. more specifically displace oxygen from the beverage prior to the addition of the nitrous oxide gas. A temperature controlled pressure vessel with gas dissolution device including venturi-type gas injectors, spray mixtures, agitators or trays can be used to increase the exposed surface area of the beverage to the gas when mixing the gas into the beverage. When the gas is mixed with the beverage, the mixture should be maintained under pressure to maintain the gas-beverage mixture. If the pressure is reduced, which is likely to occur just prior to consuming the beverage, the smaller bubbles that are captive in the mixture will expand, thereby producing the desired effect of a foamy, creamy head which can last for up to 30 minutes.

### EXAMPLE 2

In another embodiment, a beverage containing lipids is packaged without mixing the nitrous oxide gas into the beverage. Instead, a pressurized capsule containing nitrous oxide gas is added to the beverage container which is then sealed, which capsule is under a pressure that is less than a pressure of the beverage in the sealed container, but greater than atmospheric pressure. When the container is opened to release the beverage, the pressure of the beverage will be reduced considerably and such differential pressure between the capsule and the beverage will cause the capsule to rupture and allow the nitrous oxide gas in the capsule to be released from the capsule into the beverage to be mixed with the lipid-containing ingredients in the beverage.

### EXAMPLE 3

In still another embodiment, nitrous oxide gas is mixed with a beverage containing lipids, the mixing being done with a carbonator device used to dissolve CO₂ into beverages not containing lipids.

The nitrous oxide can be provided from a source such as a pressurized tank or cylinder (not shown). Even if the nitrous oxide is under pressure as a liquid in the tank, upon release, the liquid nitrous oxide will expand and phase to a gas, vapor or atomized jet or stream.

It will be understood that the embodiments described herein are merely exemplary, and that one skilled in the art may make variations and modifications without departing from the spirit and scope of the invention. All such variations and modifications are intended to be included within the scope of the invention as described hereinabove and claimed. Further, all embodiments disclosed are not necessarily in the alternative, as various embodiments may be combined to provide the desired result.

What is claimed is:

1. A method for making a foaming beverage, comprising providing a beverage having at least one lipid-based ingredient therein and mixing nitrous oxide with said beverage.

2. The method of claim 1, further comprising determining a quantity of the nitrous oxide to be mixed with the beverage based upon a selected increase in volume of foam that is to occur to the beverage.

3. The method of claim 1, wherein the beverage is non-carbonated.

4. The method of claim 1, wherein the mixing of the nitrous oxide into the beverage is at a temperature from 0° to 10° C. (32° to 50° F.).

5. The method of claim 1, wherein the mixing of the nitrous oxide into the beverage is at a pressure from 1 to 10 barg (14.5 to 145 psig).

6. The method of claim 1, further comprising displacing dissolved air in the beverage prior to the mixing of the nitrous oxide with the beverage.

7. The method of claim 1, further comprising maintaining a select pressure for the mixing and reducing the pressure prior to consuming the beverage for expanding bubbles in the beverage to provide the foam.

8. The method of claim 1, further comprising packaging the beverage in a container at a first pressure; disposing a pressurized capsule containing nitrous oxide in the container, the pressurized capsule at a second pressure less than the first pressure and greater than atmospheric pressure; opening the container to release the beverage; and rupturing the pressurized capsule to release the nitrous oxide to mix with the at least one lipid-based ingredient in the beverage.

9. The method of claim 1, further comprising increasing a pressure of the beverage for increasing an amount of the nitrous oxide to be contained in the beverage.

10. The method of claim 1, further comprising decreasing a temperature of the beverage for increasing an amount of the nitrous oxide to be contained in the beverage.

11. The method of claim 1, wherein the nitrous oxide is a gas.

12. The method of claim 1, wherein the beverage is non-carbonated.

13. The method of claim 12, wherein the non-carbonated beverage is selected from the group consisting of soda, syrup, coffee, juice, fruit-dairy mixtures and chocolate-dairy mixtures.

14. A beverage having a foam composition, comprising a liquid having at least one lipid-based ingredient therein and nitrous oxide mixed into the liquid.

15. The beverage of claim 14, wherein the liquid is non-carbonated.

16. The beverage of claim 15, wherein the non-carbonated liquid is selected from the group consisting of soda, syrup, coffee, juice, fruit-dairy mixtures and chocolate-dairy mixtures.

17. The beverage of claim 14, further comprising a container for holding the liquid at a first pressure, and a capsule with the nitrous oxide contained therein, the capsule disposed in the liquid for holding the nitrous oxide at a second pressure less than the first pressure and greater than atmospheric pressure.
